(19) United States
(12) Patent Application Publication
(10) Pub. No.: US 2021/0197569 A1
(43) Pub. Date: Jul. 1, 2021

(54) PRINTING APPARATUS WITH MULTI-HEAD CLEANING OF INKJET PRINTFACE AND METHOD OF CLEANING THEREOF

(71) Applicant: INDUSTRIAL INKJET LIMITED, Cambridgeshire (GB)

(72) Inventor: Marc Simon PLUMMER, Cambridgeshire (GB)

(21) Appl. No.: 17/273,717

(22) PCT Filed: Sep. 18, 2019
(86) PCT No.: PCT/IB2019/057870

§ 371 Date: Mar. 4, 2021

(30) Foreign Application Priority Data
Sep. 18, 2018 (GB) 1815196.9

(51) Int. Cl. B41J 2/165

(52) U.S. Cl. CPC B41J 2/16532; B41J 2002/16594; B41J 2002/16555; B41J 2/16552

(57) ABSTRACT

An inkjet printing apparatus having a printhead assembly comprises a plurality of printing heads on each of which there is defined a nozzle orifice surface having a row of nozzle orifices through which ink is ejected. The printing apparatus includes a cleaning station comprising a cleaning head array, a plurality of cleaning heads mountable on the cleaning head array and a purge tray. Ambient air is forced under vacuum into a flow channel within each cleaning head such that highly focused fluid flow is generated at the orifice surface when the flow volume impinges the profiled exterior of a vacuum outlet port provided on each cleaning head producing sufficient shear forces to remove accumulated ink and debris from the nozzle orifice surface. The invention also relates to improved cleaning heads, an array of heads in a cleaning station assembly and a method of cleaning nozzle orifice surfaces.

### FIELD OF THE INVENTION

The invention relates to inkjet printing apparatus of the type having a printhead assembly within which there is provided a plurality of printing heads. Each printing head includes a nozzle plate on which there is defined a nozzle orifice surface having a row of nozzle orifices through which ink is ejected under a microprocessor control.

The invention is particularly directed to cleaning effectively the orifices and orifice surfaces of a nozzle plate without causing physical wear to the orifice surface while effecting efficient cleaning.

Accordingly, there is provided an apparatus for and method of cleaning the nozzle plate of multiple inkjet printing heads using a fluid (primarily air) across the external face of the nozzle plate.

It will be understood by the skilled addressee that the terms ‘printing head’ and ‘printhead’ are interchangeable and the terms are not intended to be limiting and should be interpreted broadly to incorporate any common inkjet delivery device requiring a regime of maintenance and cleaning such as that described hereinafter.

It has been noted that in the prior art the term ‘wiping’, as applied to cleaning a surface with an elastomeric blade or with a material mop, has been used synonymously with ‘scraping’ which often implies the use of a rigid edge, however, is also used more broadly to describe the action of an ‘air-knife’ where a narrow blade of high velocity air is angularly directed onto a surface to remove debris therefrom. In the description that follows, the term ‘scrape’ is also used to denote an action where high shear forces are brought to bear against a surface with the intended purpose of removing ink and/or debris from the subject surface.

Additionally, the term ‘cleaning fluid’ is intended to be directed towards a fluid that removes ink and debris from a surface and is distinguished from a cleaning liquid which normally is used to dissolve, soften or dilute the ink adhering to the surface or to condition with surfactants and the like. In the present disclosure, cleaning fluid refers to ambient air and cleaning liquid (where used) is often water.

It will be appreciated by the skilled addressee that the term ‘ink’ as used herein may comprise water-based inks, solvent based inks and inks having specialised characteristics relating to curing, such as ultraviolet UV radiation curing inks, and related to security features, most commonly, radiating under UV light.

### BACKGROUND TO THE INVENTION

It is well-appreciated that inkjet printing apparatus of the present type require regular maintenance and cleaning. In use, droplets of ink become airborne as they are ejected and can adhere to the nozzle surface adjacent to and within the nozzle orifices. The build-up of ink and debris subsequently affects the ink injection performance to the extent that print quality reduces.

The prior art is replete with cleaning devices adapted to ensure the nozzle orifice surface is clean, including those devices configured to mop or wipe the nozzle surface to remove or dislodge viscous or dried-on accumulations of ink and debris reflected from the target print medium. Most commonly, a cleaning station having one or more static wiper blades is provided so that the nozzle surface is drawn across the blade to scrape off ink and particles of dust freed from the media upon which the inkjet ink is to be printed. The blades are normally formed using rubber or similar elastomeric material. Unfortunately, repeated use wears the rubber blade but, of more significance, also wears the nozzle surface over time rendering the printing head useless.

In many instances, physical wiping is the entire extent of the cleaning operation although pre-wetting of the nozzle orifice surface with a suitable solvent is not uncommon. Most frequently, these prior art publications disclose flexible wipers, however, absorbent materials in the form of pads or similar to ‘mop up’ a cleaning liquid carrying entrained contaminants are also featured.

Exemplary of the above publications are U.S. Pat. No. 5,555,461 to Xerox Corp and United States Patent Application Publication No. 2004/145623 to Samsung Electronics Co, each of which disclose a nozzle plate cleaning system having a wiper blade acting on the external surface thereof. In the Xerox disclosure, the wiper blade includes grooves cut into the wiper blade to facilitate removal of ink and debris from the nozzle plate surface by capillary action. Similarly, the Samsung disclosure describes a wiper having capillary tubes formed within the body of the blade to convey a wetting agent to the nozzle plate.

It is common to use protective coatings on the nozzle surfaces and coatings which have hydrophobic or ink repellent properties to prevent ink adherence to the surface. Nonetheless, where ink is allowed to cure on the surface, it can be difficult to remove and wiping of the surface is known to degrade the coating over time.

Commonly at the beginning and/or end of a printing job, ink is purged from the nozzles either by expelling a predetermined volume of ink and/or solvent from the nozzles and collecting the expelled volume for disposal or recycling subsequently. Purging may also be carried out by applying suction cleaning of the nozzles to vacuum out any remaining ink. U.S. Pat. No. 6,478,402 to Heidelberger Druckmaschinen is brought forward as exemplary of a method of cleaning a nozzle plate surface where a flushing stage is followed by vacuum wiping of the nozzle plate surface, where a wiper assembly collects ink and contaminants which are then drawn under vacuum away from the nozzle surface.

Again, by way of example, European Patent Publication No. EP 1 029 684 to Eastman Kodak Co discloses a wiper blade and vacuum canopy arrangement whereby a solvent delivery wiper has solvent delivery ports to flush away contaminants from the orifice surface and wicking channels to remove the solvent and debris as the wiper removes gross contaminants from the surface. Suction is applied to the wicking channels to aid removal of the solvent and debris. The optional vacuum canopy is provided for drawing debris and dried ink from within the ink channels and through the nozzle orifices under negative pressure in a flushing or purging cycle.

US Patent Application Publication No. US 2015/0144709 to Canon KK similarly describes a flushing head where contaminant is collected via a nozzle brought into proximity of the nozzle surface so that ink droplets on the surface are drawn towards an outlet port through a combination of capillary action and negative press applied through the port. Variations of the principle include a wiper blade adapted to contact the droplets and debris accumulated on the nozzle surface but without making contact with the surface itself. Thus, the contaminants to be collected are physically manipulated before being vacuumed from the nozzle orifice surface.

The purging cycle should be considered as a separate cleaning process to that applied to the external surface of the nozzle orifice plate, as the purge cycle is focused on providing fresh ink at the nozzles and flushing the nozzle orifices outwardly. While this action cleans the nozzles internally, it may not remove debris from the extremities of the orifice and certainly does not clean the exterior thereof. The purge process is often conducted under a microprocessor control in the same manner as ink is ejected during a print cycle. In some instances, the purge process is conducted using a cleaning head brought into contact with the printing head and sealingly engaged thereto. A vacuum is applied to draw ink from the nozzle orifices and, in doing so, also effect an external surface clean.

The above arrangement has a number of disadvantages associated with it, including failure over time of the vacuum seal, the flushing of too much ink during the process and commencing a siphon action where the ink continues to flow after the purge or cleaning cycle has finished. Where siphoning occurs, the problem of ink pooling becomes problematic, as will be referred to again below.

United States Patent Publication No. 2012/0105539 to Toshiba Tec KK discloses in its preamble examples from the prior art where methods for performing suction-cleaning by keeping a vacuum purge nozzle in contact with the nozzle plate or for performing suction cleaning by moving a suction nozzle along the plate but keeping a gap between the suction nozzle and the nozzle plate where the suction nozzle does not come in contact with the nozzle plate. However, if the suction force of the suction nozzle acts directly in the ink discharge direction from the nozzles orifices, the ink may easily be pulled through the nozzles, leading to the formation of bubbles in the nozzle.

The Toshiba Tec KK disclosure includes arrangements where the surface of the nozzle plate is treated for ink repellency in order to stabilize the ink discharge capability, so that when a suction cleaning is performed by the suction nozzle, ink tends to remain on the surface of the nozzle plate in the form of minute ink drops, however, the residual ink drops are not moved by the airflow alone. In this scenario, the residual ink cannot be removed from the surface of the nozzle plate, and minute ink drops remain. As a result, the ink repellency in the vicinity of the nozzle holes of the surface of the nozzle plate may deteriorate and the quality of printing may be degraded.

Chinese Utility Model Patent Publication No. CN 2510290 to Honghua Comp Technology Co discloses a cleaning head having a configuration described as an air-knife but may be more accurately be defined as an elongate vacuum nozzle in the form of a slit that is angularly presented across the orifice surface and held at a fixed distance from the surface without making contact with the surface or manipulating the ink and/or contaminants to be collected.

United States Patent Application Publication No. 2011/0074869 and its successor United States Patent Application Publication No. 2014/0373929, both to Panasonic Corp, describe an arrangement similar to an air-knife but where the gas or fluid is directed against the target surface by a curved guide section maintained a predetermined distance from the nozzle plate surface to generate the required shear force at the surface to remove contaminants. The disclosure also illustrates the manipulation of ink and/or contaminant droplets on the nozzle surface in a manner similar to that described in the Canon KK publication above. Thus, where manipulation of the contaminant to encourage capillary actions is utilised, it is essential to provide a localised air source otherwise the vacuum pressure builds, encouraging siphoning of ink from the printing head and pooling of ink in the cleaning head.

US Patent Application Publication No. US 2006/0139397 to Olympus Corp describes a multi-printing head cleaning head which operably engages the printing head so as to align channels therein with the nozzle orifice surfaces thereof to direct a suction force crossing the direction of ink discharge from the nozzles. The drawn ink and debris are then carried into suction outlets within the cleaning head. The configuration of the cleaning head means that it can only be used with printing heads having a corresponding profile to facilitate operable engagement.

As will be readily appreciated from the patent literature, there are many different approaches taken to solving some of the technical disadvantages. Each area presents specific concerns, however, many aspects are common and will be addressed hereinafter.

Chinese Patent Publication No. CN 107150505 to Panasonic IP Man Co describes a cleaning head having a vacuum outlet port to draw ink and/or cleaning solvent from the orifice surface. The cleaning head is profiled to ensure a fixed gap is maintained between the outlet port and the nozzle orifice surface, however, uses capillary action to pool contaminants adjacent the port. Restricting the air flow around the port adversely affects the pressure profile and can result in uncontrolled pooling and subsequent siphoning of ink from the printing head nozzles.

It is an object of the present invention to seek to alleviate the primary disadvantages associated with prior art inkjet printing apparatus and current methods of cleaning inkjet printhead assemblies and nozzle orifice surfaces.

It is also an object of the present invention to provide a method of cleaning nozzle orifice surfaces of a plurality of printing heads in a printhead assembly.

It is a primary objective of the present invention to ensure no ink remains on the exterior surface of the nozzle plate which could subsequently be allowed to dry or cure onto the subject surface.

It is a further object of the invention to provide a cleaning means for inkjet printhead assemblies.

It is also an object of the present invention to provide cleaning means or a cleaning head that is easily retrofittable, which is not labour-intensive to install and includes elements which may be replaced during regular maintenance.

It is an additional object of the invention to provide a cleaning head of high reliability, superior cleaning efficiency and having a component life which vastly exceeds the anticipated operational life of the apparatus to which it is fitted.

### SUMMARY OF THE INVENTION

Accordingly, the present invention provides an inkjet printing apparatus having a printhead assembly, movable between a printing position and a maintenance position, comprising a plurality of printing heads each of the type having a nozzle plate on which there is defined a nozzle orifice surface, the orifice surface being formed with a row of nozzle orifices through which ink is ejected under microprocessor control,
in which the printing apparatus includes, at the maintenance position of the printhead assembly, a cleaning station comprising a cleaning head array, a plurality of cleaning heads mountable to the cleaning head array and a purge tray,
in which a vacuum generating means is in communication with the cleaning head array such that highly focused fluid flow is presented at the orifice surface when the printing heads are juxtaposed thereto,
and in which a vacuum outlet port is provided on each cleaning head and is profiled to direct the flow against the exterior surface of the nozzle plate to scrape accumulated ink and debris from the nozzle orifice surface.

The primary embodiment of the invention provides an arrangement whereby cleaning of the nozzle orifice surfaces of a plurality of printing heads in a printhead assembly is effected by a corresponding number of cleaning heads provided on a cleaning head array at the cleaning station disposed in the maintenance position area to which the printhead assembly is moved during a purge and clean or clean only cycle of the printing heads.

Each cleaning head defines a channel along which ambient air is drawn under vacuum and directed towards a profiled vacuum port centrally disposed within the channel. The exterior surface of the port is profiled to deflect the trajectory of the air drawn along the channel towards the exterior surface of the nozzle plate in the region juxtaposed the vacuum port. Accordingly, the shear forces generated by the deflected air flow will remove any accumulated ink or debris present on the nozzle orifice surface. The high shear forces necessary to perform the cleaning action are generated by a combination of flow volume produced under vacuum, the trajectories determined by the channels provided on the upper surface of the cleaning heads and the exterior profile of the vacuum ports, together with the proximity of the vacuum port to the nozzle orifice surface during cleaning.

Optionally, the fluid flow directed against the exterior surface of the nozzle plate is sufficient to removed ink and accumulated debris from within the nozzle orifices.

As will be noted more particularly below, the proximity of the vacuum port to the nozzle orifice surface during cleaning is fixed by peripheral lands provided along the longitudinal edges of each cleaning head which, in the preferred construction thereof, also defines the channel for directing ambient air towards the vacuum port.

Advantageously, the printing apparatus includes means to move the printhead assembly progressively with respect to the cleaning head array.

Preferably, separate vacuum generating means are provided for each cleaning head of the cleaning head array.

Greater and more highly regulated fluid flow volumes are thus available within the channels of the cleaning heads and, consequently, when the flow trajectories are deflected by the exterior profile of the vacuum outlet port, more predictable shear forces are encountered at the nozzle orifice surface, leading to greater cleaning efficiencies.

Conveniently, the vacuum generating means is directly coupled to each vacuum port to draw ambient air into the channel formed in the cleaning head to accelerate and impinge on a profiled periphery of the port to generate high shear forces at the nozzle orifice surface.

Advantageously, ink and debris dislodged from the immediate vicinity of the nozzle orifice plate is drawn into the vacuum outlet port and deposited in a fluid trap from which it is pumped to waste collection.

Optionally, a cleaning fluid inlet port is provided on each cleaning head to direct a pre-wetting fluid or a cleaning liquid onto preceding regions of the nozzle orifice surface before the regions are brought progressively into juxtaposition with the vacuum port.

The present invention further provides a method of cleaning nozzle orifice surfaces of a plurality of printing heads in a printhead assembly of an inkjet printing apparatus, the method including:
at a predetermined interval in a printing cycle, conveying the printhead assembly to a cleaning station of the type having a plurality of cleaning heads mounted adjacent one another on a cleaning head array and adapted to align with nozzle orifice surfaces of respective printing heads;
enabling a vacuum generating means to draw ambient air into channels formed in each cleaning head to present highly focused fluid flow at the orifice surface;
directing said flow against a profiled peripheral surface of the vacuum outlet port formed on the cleaning head against the exterior surface of the nozzle plate to scrape accumulated ink and debris from the nozzle orifice surface;
moving the printhead assembly progressively with respect to the cleaning head array; and
drawing removed ink and debris from the region proximate the nozzle plate into said vacuum port and trapping the removed ink and debris for disposal.

Optionally, the fluid flow directed against the exterior surface of the nozzle plate is sufficient to removed ink and accumulated debris from within the nozzle orifices.

The present invention further provides a modified purge cycle comprising the steps:
engaging a vacuum source to each cleaning head of a cleaning station;
traversing a printhead assembly of an inkjet printing apparatus from a printing position across the cleaning station towards a maintenance position over a purge tray;
flushing ink from within each printing head through nozzle orifices thereof into the purge tray;
pausing to facilitate withdrawing of ink from nozzle orifices to prevent siphoning of ink;
traversing the printhead assembly towards the printing position to the cleaning station;
engaging each printing head with respective ones of the cleaning heads to perform a cleaning cycle;
returning the printhead assembly to the printing position; and
disengaging the vacuum source.

Advantageously, the steps of traversing the printhead assembly to the waste collection position, flushing, posing and cleaning is repeatable within a purge cycle.

The number of repeats is predetermined according to the characteristic of the ink in use.

Optionally, the method further comprises the step of injecting, through a cleaning fluid inlet port provided on each cleaning head, a pre-wetting fluid or a cleaning liquid onto preceding regions of the nozzle orifice surface before the regions are brought progressively into juxtaposition with the vacuum port.

The invention also provides an inkjet printing head cleaning means comprising:
a cleaning station for an inkjet printing apparatus comprising a plurality of printing head cleaning heads mounted adjacent one another on an array block and adapted to position each cleaning head into alignment with a printing head to be cleaned.

The cleaning heads further comprise couplings to connect the or each vacuum pump associated with said cleaning heads.

Advantageously, there is provided a separate vacuum source feed for each cleaning head.

Optionally, the printing head cleaning means includes a cleaning fluid reservoir and pumping means to provide a pre-wetting fluid or cleaning liquid to a cleaning fluid inlet port on each cleaning head.

The invention further provides an inkjet printing head cleaning head adapted to clean the exterior surface of a nozzle orifice plate of a printing head, the cleaning head comprising:
a body portion within which there is defined a vacuum outlet port, operably coupled to a vacuum generating source to direct ambient air into a channel formed in the body, the vacuum port having an exterior surface profiled to deflect the trajectory of the air drawn into the channel against the exterior surface of the nozzle plate in the region of the nozzle orifice surface, so as to generate high shear forces to dislodge ink and accumulated debris from the nozzle orifice surface juxtaposed the vacuum port, said ink and debris dislodged from the orifice surface being drawn into the vacuum outlet port and deposited in a fluid trap for disposal.

In a preferred embodiment, the cleaning head includes, on its upper surface, peripheral lands to define a central region of the cleaning head within which the vacuum outlet port is disposed, said lands being formed to maintain a profiled mouth of the outlet port a predetermined distance from the nozzle orifice surface when juxtaposed thereto during cleaning.

In use, the peripheral lands come into contact with the nozzle plate spaced apart on either side of a longitudinal axis of nozzle orifices.

Advantageously, the distance from the outlet port to the nozzle orifices is in the region of 75 μm to 125 μm.

Preferably, the distance from the outlet port to the nozzle orifices is maintained at 100 μm.

The invention yet further provides a kit of parts for an inkjet printing head cleaning station comprising:

a plurality of cleaning heads having mounting means for forming an array;

an array block adapted to receive a row of cleaning heads to form an array;

coupling means for attaching the cleaning heads to a vacuum source; and

means for mounting the array in a cleaning station.

### BRIEF DESCRIPTION OF THE DRAWINGS

The present invention will now be described more particularly with reference to the accompanying drawings which show, by way of example only, an exemplifying embodiment of inkjet printing apparatus and embodiments of cleaning head in accordance with the invention. In the drawings:

FIG. 1a is a perspective elevation of a printing apparatus having a printhead assembly movable from a printing position, past a cleaning station to a maintenance position where the printing heads are disposed over a purge tray and FIG. 1b is a sectional side perspective view of the printhead assembly retracted marginally from the maintenance position towards the cleaning station and about to commence a cleaning cycle;

FIG. 2a is a perspective elevation of the cleaning station and purge tray showing a cleaning head array, a plurality of vacuum source pipes for each of the cleaning heads and a waste outlet pipe and FIG. 2b is a fluid circuit diagram showing a vacuum pump and associated fluid trap for each cleaning head of the array, a waste pump to evacuate the trap and a waste collection tank coupled to each waste pump and the waste outlet pipe of the purge tray;

FIGS. 3a to 3b are perspective elevations of a cleaning head array showing a series of cleaning heads secured to a mounting or array block, FIG. 3c is a cross-sectional elevation of FIG. 3b and FIG. 3d is a perspective view of the array block of FIGS. 3a to 3c;

FIGS. 4a and 4b are perspective elevations of first and second variants of a cleaning head having full width and restricted air flow channels at one end of the head, illustrating spring-mount fixings to secure the head to the array block and couplings for a vacuum source pipe and, where required, a pre-wetting or cleaning liquid feed;

FIG. 5a is an elevation of a variant of cleaning head similar to that of FIG. 4a but having a quick-coupling connector for the vacuum source feed, FIG. 5b is a longitudinal sectional view of the head of FIG. 5a and FIGS. 5c and 5d are additional variants of cleaning head having vacuum outlet port profiles or modifications adapted to alter the fluid flow paths to increase shear forces at the nozzle orifice surface of a juxtaposed printing head

FIGS. 6a and 6b are detailed elevations of variants of the preferred embodiments of cleaning head, illustrating a vacuum outlet port having a profiled peripheral surface, fluid flow channels and in FIG. 7b an optional inlet port for a pre-wetting fluid or cleaning liquid;

FIG. 7 is a diagrammatic perspective view of a cleaning head showing flow trajectories of ambient air directed under vacuum from the vacuum port into the flow channel defined by the head and the pressure levels encountered; and

FIG. 8a is a perspective bottom view of a printing head brought into contact with a cleaning head of the invention and FIG. 8b is an exposed detailed elevation of FIG. 8a.

### DETAILED DESCRIPTION OF THE DRAWINGS

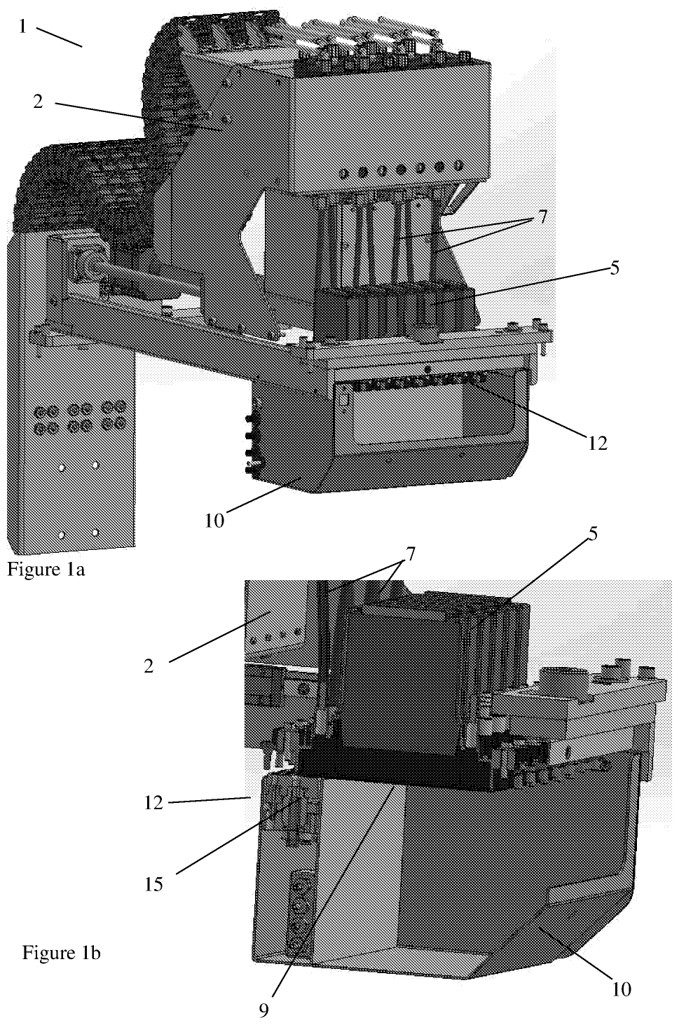

Referring to the drawings and initially to FIGS. 1a and 1b, an inkjet printing apparatus 1 of the type having an inkjet printhead assembly 2 is movable across a print media on which ink for printing is to be applied. The inkjet printhead assembly 2 comprises a plurality of inkjet printing heads 5, each having a reservoir for ink commonly fed from ink supply lines 7 and, as described hereinbelow, a printing surface comprising a nozzle plate 9 having an array of orifices formed along the longitudinal axis thereof, through which ink is ejected under microprocessor control.

The printhead assembly 2 is also movable from its printing position to a maintenance position where purging and cleaning processes are performed. The maintenance position is defined by a purge tray 10 within which there is also provided a cleaning station 12 over which the printhead assembly is moved reciprocally.

The cleaning station comprises an array of cleaning heads 15 on a mounting or array block 18 to receive respective printing heads 5 of the printhead assembly during a cleaning cycle.

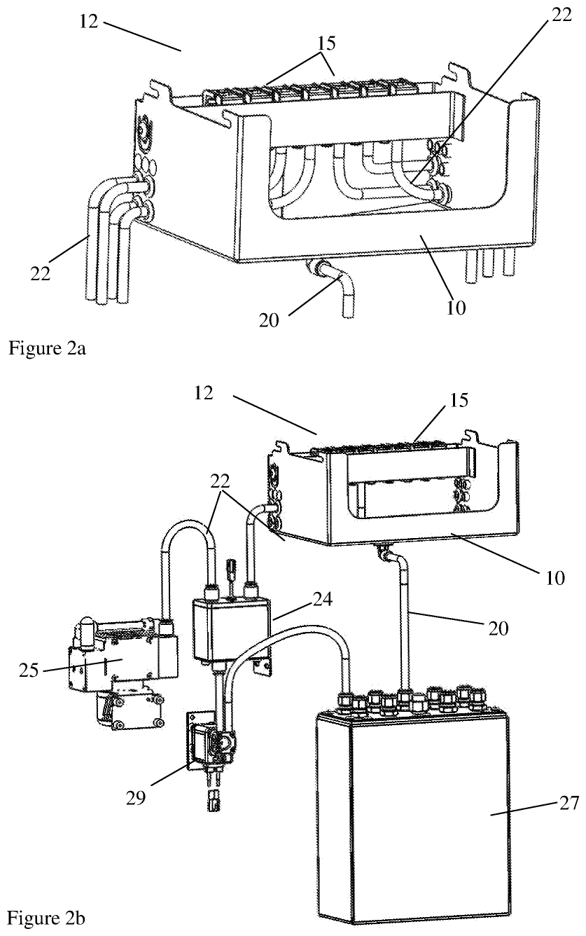

FIG. 2a shows the cleaning station 12 comprising a purge tray 10 and an array of cleaning heads 15 mounted within. As will be described in detail hereinbelow, when the printhead assembly moves to the maintenance position for commencement of the purge cycle, ink flushed through the printing heads falls into the tray 10 and is fed under gravity to a waste outlet pipe 20. Vacuum source pipes 22 pass through a side wall of the purge tray 10 and connect to respective ones of the cleaning heads 15. As detailed in FIG. 2b, each of the cleaning heads 15 of the cleaning array 12 is connected via its vacuum pipe 22 through a fluid trap 24 to a vacuum pump 25. Each fluid trap 24 is, in turn, connected to a waste collection tank 27 via a trap drain pump 29. The waste outlet pipe 20 from the purge tank 10 also feeds to the waste collection tank 27.

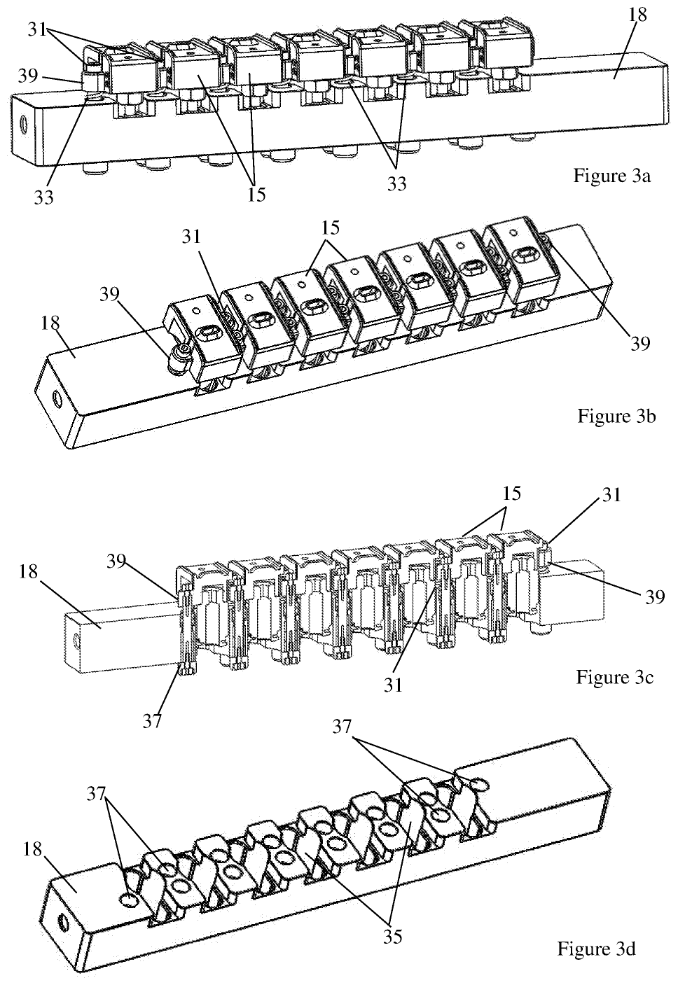

Referring now to FIGS. 3a to 3d, the cleaning head array comprises the array block 18 to which there is mounted cleaning heads 15 corresponding in number to the number of printing heads 5 in the printhead assembly 2. The cleaning heads 15 are each secured to the block 18 by a pair of threaded bolts 31 and springs 33, so as to spring-mount the heads to the block 18 and thus allow for tolerances in the distance between the block and the individual printing heads. The springs 33 also ensure the upper surface of the cleaning heads are biased against the nozzle plate 9 of the respective printing heads 5 during the cleaning cycle.

In the specific array illustrated, the array block 18 has through-holes 35 profiled to receive the fluid connectors of the respective cleaning heads and has mounting receivers 37 angularly offset on either side of the through-holes 35. Each cleaning head mounting bolt 31 freely passes through an unthreaded lug 39 correspondingly offset on each side of the body of the cleaning head 15 and retains the spring 33 in compression in an unthreaded section of the receivers 37 when engaged in the threaded end section of said receivers 37 of the array block 18. The spring mounting facilitates close engagement of the cleaning heads with the nozzle plates 9 of the printing heads when the cleaning cycle commences.

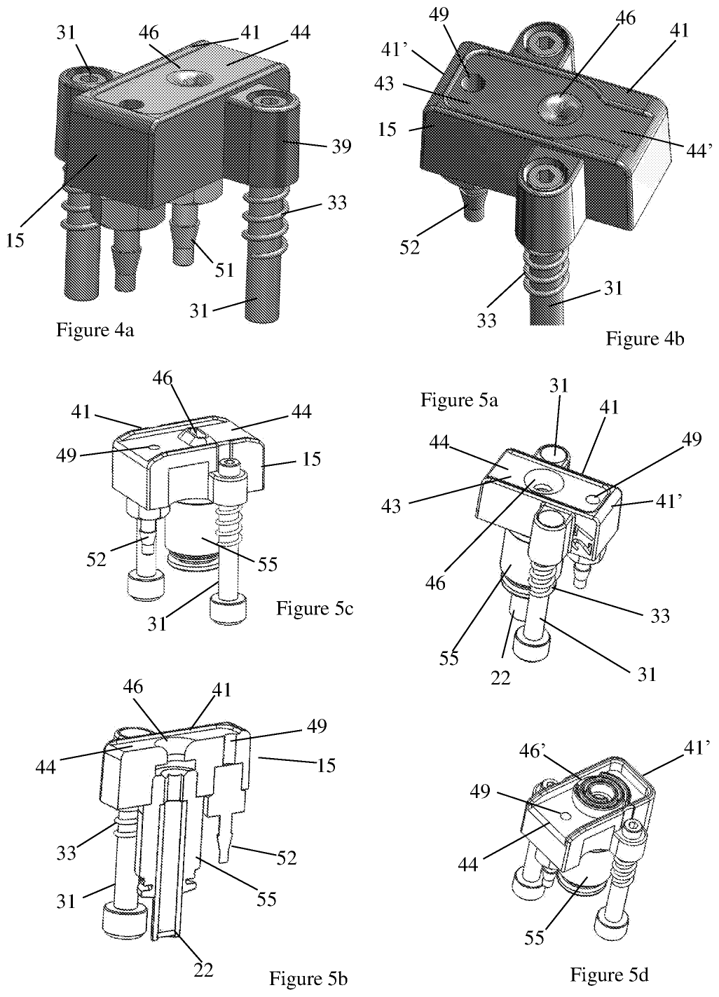

The cleaning heads 15 of the invention may be provided in a number of configurations and variants. FIG. 4a illustrates a first variant in which peripheral lands 41 are provided on the longitudinal edges of the upper surface of the cleaning head to define a through channel 44. A vacuum outlet port 46 draws ambient air along the channel 44 when the cleaning head is held in spring-biased contact with the nozzle plate 9 of the printing head 5 and flow trajectories are confined within the channel. FIG. 4b illustrates a second variant in which the longitudinal peripheral lands 41 broaden at one end to define a narrow channel mouth 44′ and are closed by a transverse land 41′ at the opposite end of the upper surface 43 of the cleaning head 15, so that flow trajectories generated under vacuum via the vacuum outlet port 46 are constrained to flow only into the narrow mouth 44′. In this variant, an inlet port 49 is provided for a pre-wetting fluid or cleaning liquid.

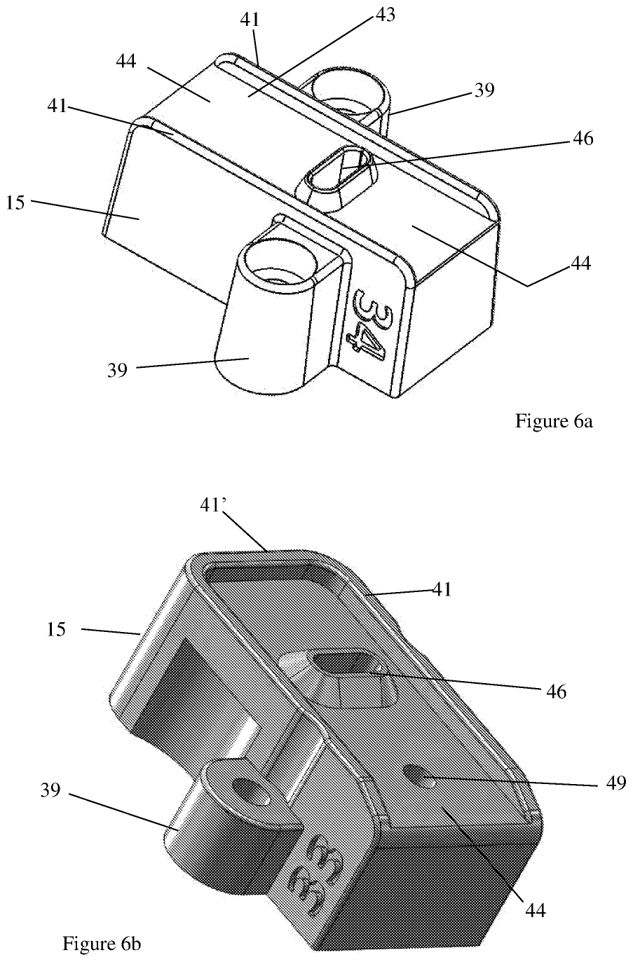

FIG. 5a corresponds to the illustration of FIG. 4a, where a quick-connect coupling 55 is provided for the vacuum source connecting pipe 22 to the vacuum outlet port coupling 51. FIG. 5b is a sectional elevation of FIG. 5a showing a quick-connect coupling 55 for the vacuum source pipe 22 and, where provided, a standard coupling 52 for the pre-wetting inlet port 49. FIGS. 5c and 5d are additional variants of the cleaning head having modified outlet port profiles adapted to increase the shear forces impinging the nozzle orifice surfaces of the target printing heads. In FIG. 5c, the flow trajectories generated along the channels 44 are deflected by the exterior profiled surface of the vacuum port 46 such that highly focused currents of air impinge the orifice surface. In the variant of cleaning head illustrated in FIG. 5d, ambient air drawn under vacuum is focused along a single channel 44 until the flow trajectories are modified by the helical structure defining the vacuum port profile 46′. In this arrangement, the flow trajectories are induced into a radial vortex which provides shear forces at the nozzle surface sufficient to remove accumulated ink and debris therefrom. As before, the removed ink and debris is drawn into the vacuum outlet port, into the fluid trap 24 for subsequent removal to waste.

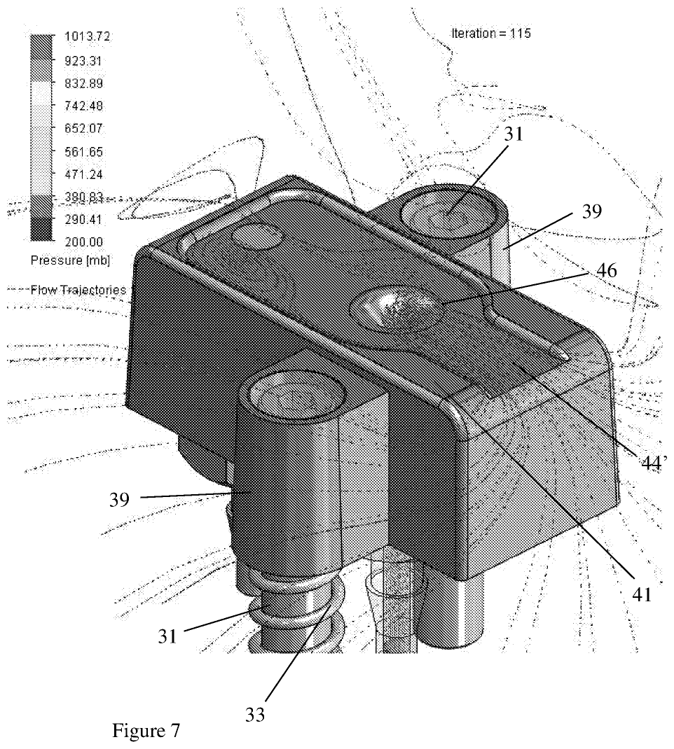

FIGS. 6a and 6b are illustrations of preferred embodiments of the cleaning head 15. In FIG. 7a, the peripheral lands 41 are open at both ends to define a through-channel 44 on the upper surface 43 of the head 15. The air flow trajectories are confined to run substantially parallel to the longitudinal axes of the peripheral lands 41 and increase in velocity as they approach the exterior profiled surface of the vacuum outlet port 46. The vacuum outlet port has an external peripheral profile which is adapted to deflect the flow trajectories generated within the channel against the nozzle orifice surface 9 when it is juxtaposed thereto during the cleaning cycle.

It will be appreciated that the longitudinal axis of nozzle orifices is parallel to and aligned with central longitudinal axis of each cleaning head when the printhead assembly is moved across the cleaning station 12.

The variant of FIG. 6b has no through-channel as one end is closed by a transverse land 41′ formed by the continuation of the longitudinal peripheral lands 41 and includes a fluid inlet port 49 connected via its respective coupling 52 to a source of pre-wetting fluid or cleaning liquid.

It should be noted that the peripheral profile of the vacuum outlet port is centrally disposed and its peripheral edges are spaced away from the peripheral lands 41 sufficiently to ensure there is no bleeding of ink from the nozzle orifice surface 9′ to the peripheral lands 41 and onto the orifice plate 9. It should be noted that the depth of the channels 44 are such that pooling can be accommodated without overwhelming the outlet port 46 and altering the vacuum pressure profile. Thus, the risk of siphoning from the printing head nozzles is eliminated.

FIG. 7 is a diagrammatic illustration of fluid flow trajectories of ambient air under influence of the vacuum, generated via the vacuum outlet port 46, into the channel 44 defined by the peripheral lands 41 of the upper surface 43 of the cleaning head 15.

It will be noted that the preferred construction of a cleaning head includes an elongate channel open at both ends with a centrally disposed vacuum outlet port having a peripheral flow profile adapted to deflect the generated flow trajectories upwardly against the nozzle plate to generate sufficient shear forces to remove ink droplets and debris accumulated thereon. The longitudinal dimension of the channel is substantially greater than its width to allow the velocity of the ambient air to be maximised before deflection by the exterior profiled surface of the outlet port 46.

The removed ink and debris is drawn under vacuum through the outlet port and into respective fluid traps 24 where, once the level of accumulated ink has reached a sufficient volume, is pumped to the waste collection tank 27.

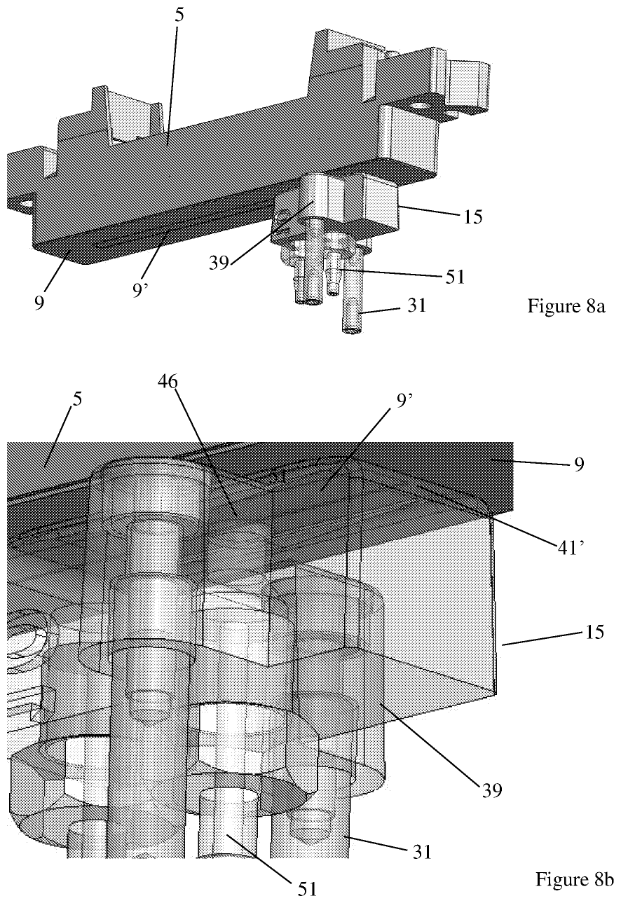

FIGS. 8a and 8b show a cleaning head 15 in juxtaposition to a nozzle plate 9 of a printing head 5. The nozzle plate 9 protects the central longitudinal nozzle orifice surface 9′ to be cleaned as the printing head is moved progressively over the cleaning station 15.

When a cleaning procedure is required, the printing head assembly 2 is moved from the printing position to the maintenance position passing over the cleaning station 12 to initiate a purge cycle above the purge tray 10.

As the printhead assembly 2 moves over the cleaning station 12, the vacuum source 25 is engaged to each cleaning head of the cleaning station and the printhead assembly stops over the purge tray 10 to commence the purge cycle. Ink is flushed from within each printing head out through the nozzle orifices into the purge tray. When flushing is complete, a period is allowed to facilitate withdrawal of the ink meniscus back into the nozzle orifices so that siphoning is prevented during the cleaning phase. The printhead assembly is traversed rearwardly towards the printing position to the cleaning station where the cleaning heads are mounted adjacent one another on an array and adapted to align with the nozzle orifice surfaces of the respective printing heads which are brought into contact with the upper surface of the cleaning heads.

By the action of the spring mountings, each cleaning head is held against the nozzle plate and the vacuum outlet port 46 is positioned juxtaposed the nozzle orifice surface 9′ at a fixed distance determined by the height of the peripheral lands 41 of the cleaning heads with respect to the upper profiled edge of the vacuum port. The gap between the upper region of the profiled vacuum port is maintained at all times at this constant distance, ideally in the region of 50 to 150 μm and most preferably maintained at 100 μm.

The printing head is progressively moved along the cleaning head so that the vacuum port is successively brought along the longitudinal axis of the printing head so that each orifice in the nozzle orifice surface 9′ is exposed to the high shear forces generated at the outlet port.

According to the type or characteristic of the ink used for printing, the flushing step is recommenced once the printing head has moved over the purge tray.

The number of repeats is predetermined according to the characteristic of the inks in use.

It will of course be understood that the invention is not limited to the specific details described herein, which are given by way of example only, and that various modifications and alterations are possible within the scope of the appended claims.

1. An inkjet printing apparatus having a printhead assembly, movable between a printing position and a maintenance position, comprising a plurality of printing heads each of the type having a nozzle plate on which there is defined a nozzle orifice surface, the orifice surface being formed with a row of nozzle orifices through which ink is ejected under microprocessor control,
in which the printing apparatus includes, at the maintenance position of the printhead assembly, a cleaning station comprising a cleaning head array, a plurality of cleaning heads mountable to the cleaning head array and a purge tray,
in which a vacuum source is in communication with the cleaning head array such that highly focused fluid flow is presented at the orifice surface when the printing heads are juxtaposed thereto,
and in which a vacuum outlet port is provided on each cleaning head and is profiled to direct the flow against the exterior surface of the nozzle plate to scrape accumulated ink and debris from the nozzle orifice surface.

2. An inkjet printing apparatus as claimed in claim 1, in which the printhead assembly is progressively movable with respect to the cleaning head array.

3. An inkjet printing apparatus as claimed in claim 1, in which separate vacuum sources are provided for each cleaning head of the cleaning head array.

4. An inkjet printing apparatus as claimed in claim 1, in which the vacuum source is directly coupled to each vacuum port to draw ambient air into a channel formed in the cleaning head to accelerate and impinge on a profiled periphery of the port to generate high shear forces at the nozzle orifice surface.

5. An inkjet printing apparatus as claimed in claim 1, in which ink and debris dislodged from the immediate vicinity of the nozzle orifice plate is drawn into the vacuum outlet port and deposited in a fluid trap from which it is pumped to waste collection.

6. An inkjet printing apparatus as claimed in claim 1, in which the fluid flow directed against the exterior surface of the nozzle plate is sufficient to removed ink and accumulated debris from within the nozzle orifices.

7. An inkjet printing apparatus as claimed in claim 1, in which a cleaning fluid inlet port is provided on each cleaning head to direct a pre-wetting fluid or a cleaning liquid onto preceding regions of the nozzle orifice surface before the regions are brought progressively into juxtaposition with the vacuum port.

8. A method of cleaning nozzle orifice surfaces of a plurality of printing heads in a printhead assembly of an inkjet printing apparatus, the method including:
at a predetermined interval in a printing cycle, conveying the printhead assembly to a cleaning station of the type having a plurality of cleaning heads mounted adjacent one another on a cleaning head array and adapted to align with nozzle orifice surfaces of respective printing heads;
enabling a vacuum source to draw ambient air into channels formed in each cleaning head to present highly focused fluid flow at the orifice surface;
directing said flow against a profiled peripheral surface of the vacuum outlet port formed on the cleaning head against the exterior surface of the nozzle plate to scrape accumulated ink and debris from the nozzle orifice surface;
moving the printhead assembly progressively with respect to the cleaning head array; and
drawing removed ink and debris from the region proximate the nozzle plate into said vacuum port and trapping the removed ink and debris for disposal.

9. A method of cleaning nozzle orifice surfaces as claimed in claim 8, in which the method further provides a modified purge cycle comprising the steps:
engaging a vacuum source to each cleaning head of a cleaning station;
traversing a printhead assembly of an inkjet printing apparatus from a printing position across the cleaning station towards a maintenance position over a purge tray;
flushing ink from within each printing head through nozzle orifices thereof into the purge tray;
pausing to facilitate withdrawing of ink from nozzle orifices to prevent siphoning of ink;
traversing the printhead assembly towards the printing position to the cleaning station;
engaging each printing head with respective ones of the cleaning heads to perform a cleaning cycle;
returning the printhead assembly to the printing position; and
disengaging the vacuum source.

10. A method of cleaning nozzle orifice surfaces as claimed in claim 8, in which the steps of traversing the printhead assembly to the maintenance position, flushing, pausing and cleaning is repeatable within a purge cycle.

11. A method of cleaning nozzle orifice surfaces as claimed in claim 10, in which the number of repeats is predetermined according to the characteristics of the ink in use.

12. A method of cleaning nozzle orifice surfaces as claimed in claim 8, in which the method further comprises the step of injecting, through a cleaning fluid inlet port provided on each cleaning head, a pre-wetting fluid or a cleaning liquid onto preceding regions of the nozzle orifice surface before the regions are brought progressively into juxtaposition with the vacuum port.

13. A method of cleaning nozzle orifice surfaces as claimed in claim 8, in which the fluid flow directed against the exterior surface of the nozzle plate is sufficient to removed ink and accumulated debris from within the nozzle orifices.

14. An inkjet printing head cleaning system for an inkjet printing apparatus of the type claimed in claim 1 comprising:
a cleaning station for an inkjet printing apparatus comprising a plurality of printing head cleaning heads mounted adjacent one another on an array block and adapted to position each cleaning head into alignment with a printing head to be cleaned.

15. An inkjet printing head cleaning system as claimed in claim 14, in which the cleaning system further comprises couplings to connect the or each vacuum pump associated with said cleaning heads.

16. An inkjet printing head cleaning system as claimed in claim 14, in which there is provided a separate vacuum source feed for each cleaning head.

17. An inkjet printing head cleaning system as claimed in claim 14, in which the cleaning means system includes a cleaning fluid reservoir and pumping means to provide a pre-wetting fluid or cleaning liquid to a cleaning fluid inlet port on each cleaning head.

18. An inkjet printing head cleaning head adapted to clean the exterior surface of a nozzle orifice plate of a printing head, the cleaning head comprising:
a body portion within which there is defined a vacuum outlet port, operably coupled to a vacuum generating source to direct ambient air into a channel formed in the body, the vacuum port having an exterior surface profiled to deflect the trajectory of the air drawn into the channel against the exterior surface of the nozzle plate in the region of the nozzle orifice surface, so as to generate high shear forces to dislodge ink and accumulated debris from the nozzle orifice surface juxtaposed the vacuum port, said ink and debris dislodged from the orifice surface being drawn into the vacuum outlet port and deposited in a fluid trap for disposal.

19. An inkjet printing head cleaning head as claimed in claim 18, in which the cleaning head includes, on its upper surface, peripheral lands to define a central region of the cleaning head within which the vacuum outlet port is disposed, said lands being formed to maintain a profiled mouth of the outlet port a predetermined distance from the nozzle orifice surface when juxtaposed thereto during cleaning.

20. An inkjet printing head cleaning head as claimed in claim 19, in which, in use, the peripheral lands come into contact with the nozzle plate spaced apart on either side of a longitudinal axis of nozzle orifices.

21. An inkjet printing head cleaning head as claimed in claim 19, in which the distance from the outlet port to the nozzle orifices is in the region of 50 μm to 150 μm.

22. An inkjet printing head cleaning head as claimed in claim 21, in which the distance from the outlet port to the nozzle orifices is maintained at 100 μm.

23. (canceled)
